(19) United States
(12) Patent Application Publication
(10) Pub. No.: US 2022/0215250 A1
(43) Pub. Date: Jul. 7, 2022

(54) AUTOMATIC PREDICTION OF THE USABILITY OF CONCRETE FOR AT LEAST ONE INTENDED USE AT A CONSTRUCTION SITE

(71) Applicant: Peri AG, Weissenhorn (DE)

(72) Inventors: Helmut Baechle, Weissenhorn (DE); Henning Staves, Weissenhorn (DE); Vanessa Bernard, Weissenhorn (DE); Ruediger Baumann, Weissenhorn (DE)

(21) Appl. No.: 17/601,309

(22) PCT Filed: Mar. 20, 2020
(86) PCT No.: PCT/EP2020/057832

§ 371 Date: Oct. 4, 2021

(30) Foreign Application Priority Data
Apr. 3, 2019 (DE) 10 2019 108 779.1

(51) Int. Cl. G06N 3/08; G06Q 50/08

(52) U.S. Cl. CPC G06N 3/08; G06Q 50/08

(57) ABSTRACT

Method (100) for training an artificial neural network, KNN (1), which predicts and/or classifies at least one quality measure (23a, 23b) for the usability of a batch of concrete (2) on a construction site.

A method (200) for predicting and/or classifying the usability of a batch of concrete (2) on a construction site, comprising the steps of:
a set of characteristics (21) characterising the material composition of the batch (2) is determined (210);
at least one measure (22) of the mechanical consistency of the batch (2) is determined (220);
the characteristics (21) and the measure (22) of mechanical consistency are fed (230) to a trained KNN (1) as inputs (11);
at least one prediction and/or classification (23a*, 23b*) for a quality measure (23a, 23b) for the usability of the batch (2) for at least one intended use on the construction site is retrieved (240) as an output (13) from the KNN (1).

A method (300) for tracking the use of a batch of concrete (2) with a blockchain (4) and a smart contract (5) operating thereon.

The invention relates to the evaluation and further processing of externally supplied batches of concrete on construction sites.

### REFERENCE TO RELATED APPLICATIONS

This application claims priority to German Patent Application No. 10 2019 108 779.1, filed Apr. 3, 2019, which is incorporated herein by reference in its entirety.

### STATE OF THE ART

The processing of concrete on construction sites can only be planned in advance to a certain extent. In some respects, a construction site is always batch size 1, i.e. a one-off production. For example, the requirements for the concrete to be used often depend on the conditions of the specific formwork. Also, the properties of concrete are not always and everywhere the same, even if a previously determined recipe has been followed exactly, since, for example, the physical properties of sand and gravel are different for each natural reservoir from which these natural raw materials have been extracted.

As a result, situations may arise where a specific batch of concrete delivered is not suitable for a specific use intended at the construction site. Such situations require quick solutions as to how the batch is to be handled and lead to delays, as at a point where the formwork is already ready, usable concrete has to be waited for.

### OBJECT AND SOLUTION

It is therefore the object of the invention to make the usability of specific batches of concrete more predictable.

This object is solved according to the invention by a method for training an artificial neural network according to the main claim, by a method for predicting and/or classifying the usability of a batch of concrete according to the subclaim, and by a method for tracking the use of a batch of concrete according to a further subclaim. Further advantageous embodiments result from the subclaims referring back thereto.

### DISCLOSURE OF THE INVENTION

In the context of the invention, a method for training an artificial neural network, KNN, has been developed. This KNN predicts at least one quality measure for the usability of a batch of concrete at a construction site, and/or it classifies this quality measure. The behavior of the KNN is characterized by a set of parameters, which may include, for example, the weights by which the respective inputs supplied to a neuron, and/or other computational unit, are computed to activate the neuron.

In this method, a set of learning data sets is provided. Each learning data set comprises, for a batch of concrete, a set of parameters characterizing the material composition of the batch. The material composition may include, for example, the type and mix ratio of the constituents of the concrete.

The learning data set further comprises at least one measure of the mechanical consistency of the batch, such as flowability, which can be determined using, for example, the standardized spreading test.

Furthermore, the learning data set comprises at least one value for a quality measure that characterizes the usability of the batch for at least one intended use on the construction site. This quality measure may, for example, have been empirically determined for the particular batch of concrete by a human expert. In the simplest case, the quality measure may be binary (acceptance or rejection for the respective intended use), but it may also indicate, for example, a scalar quality index related to the respective intended use. In particular, a single KNN may simultaneously provide quality measures related to several different uses on the site, for example combined in a vector. In particular, the time-temperature behaviour of the curing of the batch of concrete may be decisive for the quality measure. For example, it may be asked after which period of time the concrete has hardened at a given temperature to such an extent that the concrete can be stripped and the formwork elements can be used for shuttering the next cycle. The recognition of patterns in a large number of states of batches of concrete can be used, for example, to improve the quality of the concrete.

During training, for each learning data set, the set of characteristics contained therein and the measure of mechanical consistency contained therein are fed to the KNN as inputs in order to obtain from the KNN a prediction and/or classification for the at least one quality measure as output. This prediction and/or classification for the quality measure is compared to the value for the quality measure contained in the learning data set. A cost function is applied that dependsΔ on a deviation determined in the comparison. The parameters, and/or the learning data sets, of the KNN are adjusted with the optimization goal of improving the value of the cost function. Adjustment of the learning data sets may include, for example, underweighting or discarding learning data sets with errors or uncertainties in the data so that they do not bias the result of the training.

Starting from, for example, random initial values, the parameters of the KNN develop in the course of such training in such a way that the KNN predicts the quality measure for usability contained in the learning data set more or less well for the characteristic quantities contained in each learning data set in conjunction with the respective measure for mechanical consistency. This means that the experience gained in the learning data sets regarding the usability of different batches of concrete can be used to make accurate predictions for the usability of future batches. If the quantity of learning data sets is sufficiently large and diverse, the KNN can generalize the knowledge contained therein to the extent that it subsequently predicts the quality measure for the usability of the batch of concrete in question for the specific intended use on the construction site with sufficient accuracy even for completely unknown combinations of parameters and mechanical consistencies. It is the ability of KNNs to generalize that is important in the context of concrete evaluation. As mentioned at the outset, concrete is made from natural resources obtained from local reservoirs of the particular supplier. If a similar building with the same formwork is constructed at a distant site, it is very likely that, for example, the sand and gravel will come from different natural reservoirs and thus have different physical properties than at the first construction site.

However, a similar effect can already occur, for example, if the supplier for the concrete has to be changed during the transition from a first construction site to a second construction site in the vicinity, for example, because the previous supplier is currently working to capacity. Different suppliers do not usually share their raw material sources with each other.

Furthermore, differences between different batches of concrete can become apparent to different degrees depending on the temperature, for example. For example, a change in material composition in midsummer can have hardly any effect on the flowability of the concrete, while the same change makes the concrete significantly more viscous in winter.

Therefore, in a further particularly advantageous embodiment, the learning data set additionally includes.
an identification of the place where at least one raw material used for the batch of concrete was obtained, and/or
an identification of the supplier of the batch of concrete, and/or
a measure of the ambient temperature at the time the quality measure is determined, and/or
information on what is being built on the site, and/or
information as to where the batch of concrete is being delivered, and/or
at least partial planning data for the building to be constructed, and/or
at least one extract from a Building Information Model, BIM, of the building to be constructed, and/or
information on the origin, nature and/or consistency of at least one constituent of the batch of concrete, and/or
information as to the proportion of at least one constituent of the batch of concrete that is naturally derived material and the proportion of that constituent that is recycled material,
   as further inputs to be fed into the KNN.

The BIM is to be regarded as a “digital twin” of the building to be constructed and can, for example, contain information beyond the geometric structure of the building as to which concrete quality is to be used at which point. The consistency of the at least one constituent, as well as the consistency of the batch of concrete as a whole, may be measured, for example, using the spreading test. The information as to the extent to which at least one constituent of the batch of concrete is recycled material can be used, for example, in order to sound out, in the interest of conserving resources, up to what proportion naturally obtained material can be replaced by recycled material without the quality of the concrete as a whole suffering.

In a particularly advantageous embodiment, the KNN to be trained is configured to additionally predict and/or classify at least one climate parameter of the batch of concrete. The climate parameter is a parameter for a climate effect to be attributed to the batch of concrete.

Accordingly, at least some of the learning data sets, preferably all of the learning data sets, each also comprise the value of the climate variable for the respective batch of concrete to which they relate. During training, the KNN additionally determines a prediction for the climate variable from the characteristics and the measures of mechanical consistency in the learning data sets. This prediction is compared with the value for the climate variable contained in the respective learning data set. Accordingly, the cost function used for training also depends on the deviation Δ′ determined in this comparison.

In this way, the fully trained KNN is also able to quantify the climate impact of the respective batch of concrete. This makes it possible, for example, to determine the climate impact of the complete building made of many batches of concrete with greater accuracy. In various countries and regions, governmental steering systems are being discussed or are being set up, according to which every citizen and every company that causes a climate impact through certain activities owes a tax or levy graded according to this impact and/or must buy corresponding pollution rights in national or international emissions trading. Accordingly, the total costs incurred for the construction of a building will in future depend more on the climate impact of the concrete used. In the event of further tightening of environmental legislation, it is also possible that a construction project will have to be interrupted or may not even be started due to an excessive climate impact.

Already today, the expected climate impact is an important factor in tender competitions for the construction of buildings as well as for the environmental certification of buildings. For example, public financial support for the construction of a building can be linked to the condition that the building meets the criteria for environmental certification. Building permits may also be subject to such conditions.

The climate variable may in particular include, for example, a measure of the amount of at least one greenhouse gas emitted as a result of the production and/or use of the batch of concrete and/or bound in the batch of concrete. A greenhouse gas that may be considered here is in particular _{CO2}, which is produced, for example, during the production and processing of cement. The climate variable can also aggregate different types of climate impact, for example according to a weighting system or point system.

In the method for predicting and/or classifying the usability of a batch of concrete on a construction site, a fully trained KNN is used. As explained before, the KNN only has to be trained once and can then be used in a multitude of even completely unknown situations. This so-called inference from the trained KNN requires considerably less computing power than the training and can therefore be performed well by mobile devices available on construction sites, for example.

A set of parameters characterizing the material composition of the batch is determined for predicting and/or classifying the usability. Furthermore, at least one measure of the mechanical consistency of the batch is determined. In each case, the determination can be carried out on the basis of a manufacturer's specification, on the basis of a measurement (for example using the spreading test) or on the basis of any combination of manufacturer's specifications and measurements.

The characteristics and the measure of mechanical consistency are fed as inputs to a trained KNN. At least one prediction and/or classification for a quality measure for the usability of the batch for at least one purpose on the construction site is retrieved as output from the KNN.

Analogous to the previously described, at least one prediction and/or classification of a climate variable that is a parameter for a climate impact attributable to the batch of concrete may additionally be retrieved as an output from the trained KNN. This climate variable may in particular include, for example, a measure of the amount of at least one greenhouse gas emitted as a result of the production and/or use of the batch of concrete and/or bound in the batch of concrete.

Analogous to what has been described above, the KNN can also be provided with
an identification of the place where at least one raw material used for the batch of concrete was obtained, and/or
an identification of the supplier of the batch of concrete, and/or
a measure of the ambient temperature on the construction site

as inputs in order to be able to take into account the influences of these parameters on the usability.

In another particularly advantageous embodiment, in response to a quality measure predicted for a first use not satisfying a predetermined quality criterion, a further prediction and/or classification for a second use is retrieved as output from a trained KNN. As previously explained, the same KNN may provide predictions and/or classifications for multiple quality measures for different uses at once, for example combined into one vector. In other words, the evaluation of one and the same learning data pool of the KNN may provide one or more predictions for quite different uses.

In this way, for example, in the surprising situation mentioned at the beginning that a batch of concrete proves not to be suitable for the first intended use despite nominal compliance with a given recipe, a quick alternative can be provided for use. There is regularly not much time available for the search for alternatives, as the concrete, once mixed, has to be moved constantly and starts curing as soon as the movement stops. The automated search via the KNN ensures in particular that the batch of concrete is supplied to its highest value use that is still possible. This reduces the probability that a batch of concrete can no longer be used at all on the construction site and has to be disposed of as waste.

In a further advantageous embodiment, provided that the predicted quality level for an intended use satisfies a predetermined quality criterion, means for feeding the batch to that intended use may be controlled. For example, at least one concrete distribution or conveying device may be controlled to direct the batch to where it is needed according to the intended use. For example, an electronic instruction may also be sent to a human or automatically controlled concrete transport vehicle to drive to the intended use location for the batch at the construction site and to fill the batch into a specific space.

In a further particularly advantageous embodiment, the quality criterion can additionally depend on the predicted climate variable for the batch of concrete. In this case, the climate variable can be weighted as desired in relation to the actual quality criterion, depending on the significance of the climate effect in the context of the overall construction project.

In this context, the climate impact quantifiable with the climate parameter and the quality of the concrete quantifiable with the quality parameter can be linked non-linearly with regard to the intended use, for example. For example, an increase in the quality of the concrete, which raises its quality factor from 80% to 100%, may require the use of energy and materials which catapults the climate impact upwards by a factor of 5.

This in turn can already have an impact on the planning stage of the construction project. A slender concrete structure that requires only a small volume of concrete and therefore needs concrete with the 100% quality and the highest ecological “footprint” may be subject to such a high penalty due to the aforementioned steering systems that a more solid structure with twice the amount of concrete, which only needs to be of 80% quality, is more economical.

The invention also relates to a method of tracking the use of a batch of concrete, which is closely related to the methods previously described. In this method, a set of parameters characterizing the material composition of the batch and/or one or more hash values formed from these parameters are stored in association with the batch in a blockchain.

In this context, a blockchain is a distributed data store in which blocks that each contain user data also contain one or more hash values of previous blocks. In this way, the blocks are chained together in such a way that the user data in one of the blocks in the chain cannot be changed unnoticed unless all subsequent blocks in the chain are also adjusted accordingly. Blockchains, especially in distributed networks such as the Internet, are now usually managed in such a way that several participants in the network must “compete” to be able to add the next block to the blockchain by solving complex computational problems. Thus, the subsequent modification of the history usually requires a technically and financially unaffordable effort. Prominent examples of blockchains are the Bitcoin blockchain, which acts as the global “land register” for all Bitcoins existing worldwide, and the Ethereum blockchain. The latter not only serves as the “land register” for all units of the cryptocurrency Ether, analogous to the Bitcoin blockchain, but is also explicitly designed to store user data of any kind and to run “smart contracts” automatically.

The most important features of public blockchains such as the Bitcoin blockchain or the Ethereum blockchain are that data can be stored in a captive and subsequently unchangeable manner. At the same time, the data is publicly available to everyone. If this is not desired, private blockchain networks can also be used,

The deposit of hash values of the parameters that characterize the material composition can, for example, conceal the exact material composition when using a public blockchain.

A storage “in association with the batch” means that there is a way to retrieve exactly the information belonging to a given batch from the blockchain. For this purpose, the information can, for example, be stored in the blockchain in combination with an identification feature of the batch.

Parameters that characterize the material composition of the batch, or hash values thereof, can be stored in the blockchain, for example, by the manufacturer of the batch, such as a cement plant.

Furthermore, a measure of the mechanical consistency of the batch is physically determined, for example with the spreading test, and stored in the blockchain in association with the batch. This can be done, for example, by the recipient of the concrete at the construction site, which makes sense insofar as the properties of the concrete may still have changed on the transport route from the cement plant to the construction site.

Furthermore, a quality measure for the usability of the batch for at least one intended use on the construction site is determined and stored in the blockchain in association with the batch. This can also be done, for example, by the recipient of the concrete at the construction site.

In this context, depositing the information in the blockchain offers the particular advantage that it enables information from different information sources to be merged and, at the same time, is protected against subsequent manipulation without passwords or other access data to be managed centrally. Protection against manipulation is important because the data may later be needed for evidentiary purposes. For example, the stability of buildings made with concrete could later be questioned due to accusations of poor quality against the manufacturer of the concrete. Likewise, for example, part of the price of the concrete could later be reclaimed from the manufacturer with the argument that poor quality was repeatedly delivered during a certain period of time, which could only be used for low purposes.

In a particularly advantageous embodiment, at least one climate parameter, which is a parameter for a climate impact to be attributed to the batch of concrete, is additionally determined and stored in the blockchain in association with the batch. This climate variable can be determined, for example, using the method described previously, but also in any other way. The tamper-proof storage in the blockchain allows, for example, the complete ecological “footprint” of the building to be documented conclusively and permanently.

In a particularly advantageous embodiment, the quality measure is retrieved as a prediction and/or classification from a trained KNN using the method described above, and/or it is at least plausibility checked with a prediction and/or classification obtained in this way. For example, the deposit of a very bad value for the quality measure in the blockchain may be rejected if, other things being equal, a very good value for the quality measure would have been expected according to the trained KNN. A medium value for the quality measure, on the other hand, is accepted in the same situation, since a fluctuation between “very good” and “medium” is plausible due to the physical variabilities in the process.

In this way, it can at least be made more difficult for particularly bad ratings to be intentionally deposited in the blockchain with fraudulent intent. The fraudulent intent could be, for example, to blackmail the manufacturer of the concrete or to later demand a part of the paid price back from him with reference to the allegedly poor quality.

In another particularly advantageous embodiment, the actual purpose for which the batch of concrete is used at the construction site is stored in association with the batch in the blockchain. As previously explained, this information may be relevant, for example, to a price reduction based on quality defects. For example, it may be contractually stipulated that for a batch that is nominally of higher quality, but could actually only be used for a significantly less demanding purpose, only the price for which a batch of this lower quality would normally have been delivered is to be paid.

In another particularly advantageous embodiment, a smart contract operating on the blockchain determines a price for the batch based on the data stored in the blockchain in association with the batch according to predetermined criteria and credits the supplier of the batch.

In this context, a smart contract is a program that runs synchronously on all participating nodes of the blockchain, i.e. performs the same operations. In particular, a smart contract can access all data stored in the blockchain, but can also register new information for addition to the blockchain. Within the blockchain, the smart contract may in particular be managed as an entity that can receive and independently manage funds in the cryptocurrency underlying the blockchain. For example, the smart contract can initially receive the maximum purchase price from the buyer of the concrete and later transfer the set price to the supplier, while the buyer receives the remaining amount back.

In this way, price changes resulting from quality defects in particular can be made and automatically enforced according to clearly comprehensible objective criteria. Corresponding time-consuming discussions are no longer necessary.

Therefore, advantageously, the previously established criteria depend at least on the quality measure for the usability of the batch for the at least one use on the construction site, and/or on the actual use for which the batch was used on the construction site.

Similarly, the criteria previously established within the smart contract may also depend on the climate quantity for the batch. In particular, this climate quantity may be retrieved, for example, from the blockchain, but may also be procured from any other source. For example, the levy due for the climate impact may be withheld from money due to the levy debtor and paid to the competent authority at the moment it arises under the provisions of the said governance system.

As a rule, the criteria stored in the Smart Contract cannot be changed afterwards. Any such possibility of change would have to be explicitly provided for in the program code of the smart contract from the outset, which in turn could be seen in the program code.

The definition and automatic enforcement of terms and conditions by means of smart contracts can also be extended to other actors in connection with the construction site. For example, in addition to the construction site itself and the cement plant, a planning office, a general contractor and a formwork manufacturer are often involved. For example, an overall plan of the construction project can be stored in the blockchain. The construction progress can be recorded electronically with any indicators at the construction site and also stored in the blockchain. The smart contract can then, for example, automatically instruct partial payments to certain actors when certain milestones defined in the overall planning have been reached.

In this way, the entire construction project can be better protected against one of the parties being taken advantage of. For example, the smart contract can stipulate that the client must hand over part or all of the construction sum to the smart contract for fiduciary management at the start of the construction project. This ensures that all parties providing services in connection with the construction project are compensated from liquid funds after their respective services have been rendered. There is no risk, as is usual in the case of delivery and performance on open account, that the client will run into payment difficulties and that the actors who have performed in advance will, in turn, have a liquidity problem while they take legal action to collect the outstanding money.

Conversely, the client has the certainty that payments will only be made for those deliveries and services that have actually been provided. Although he must hand over money to the smart contract for fiduciary administration, this does not mean that he has to make advance payments to any of the players. So, for example, if one of the players, such as the cement plant, goes bankrupt, none of the principal's capital is lost.

The fiduciary management of funds by the smart contract further precludes any person from gaining direct access to those funds and an opportunity to misappropriate them. Funds once transferred to the smart contract for fiduciary management will only be released under the conditions set forth in the smart contract, such as when certain milestones are reached. The smart contract can also contain resolutive conditions, for example, such that the construction project is officially declared a failure if no construction progress is made for a certain period of time and the builder receives his money deposited in the smart contract back after all actors have been compensated for their services already rendered.

Delivery notes, for example, can also be stored in the blockchain. These are then both captive and protected against manipulation.

The data stored in the blockchain can, for example, be fed back to the manufacturer of the concrete and used there to improve the concrete quality. Furthermore, the permanent storage of data in the blockchain makes it possible to document, for example, compliance with specifications of the concrete used, which is important with regard to stability, even over periods of time in the order of magnitude of the life cycle of buildings. For example, in response to the fact that defects come to light in the data from the construction period, examinations of parts of the building can be initiated in retrospect or regular inspection intervals in this regard can be shortened.

The invention also relates to an artificial neural network trained using the previously described training method. Similarly, the invention also relates to a data set of parameters characterizing a KNN obtained using said training method. For example, the highly computationally intensive training, which often requires GPUs with unusually large video memory, may be provided as a service and the dataset may be provided as a work product of said service.

The invention also relates to one or more computer programs having machine-readable instructions that, when executed on one or more computers, and/or on a blockchain, cause the one or more computers, and/or the blockchain, to perform one or more of the methods previously described. For example, a program running on the blockchain may interact with other programs that transfer information to or obtain information from the blockchain.

The computer program(s) may be embodied, for example, on a machine-readable medium or a downloadable product that can be acquired and loaded over a network.

### SPECIAL DISCLOSURE PART

Hereinafter, the subject matter of the invention will be explained with reference to figures without limiting the subject matter of the invention herein. It is shown:

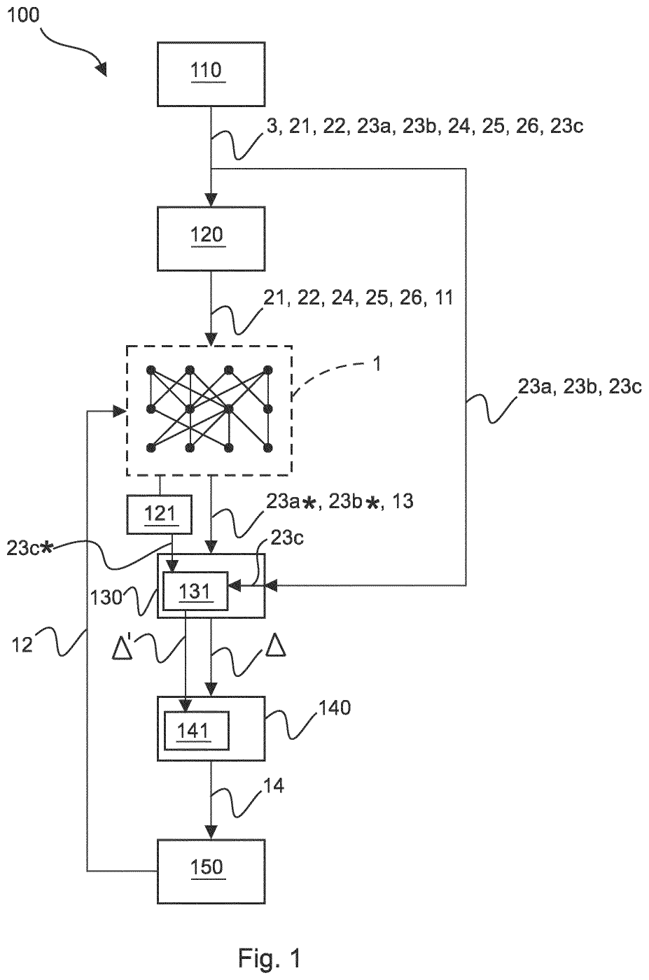

FIG. 1: An embodiment of the method 100 for training the KNN 1;

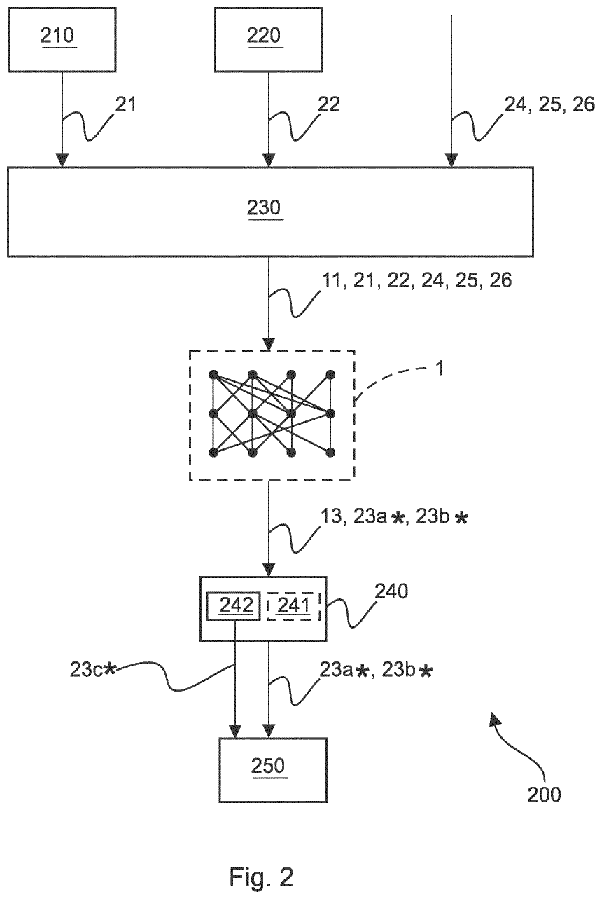

FIG. 2: Example of embodiment of method 200 for predicting and/or classifying the usability of a batch of concrete 2;

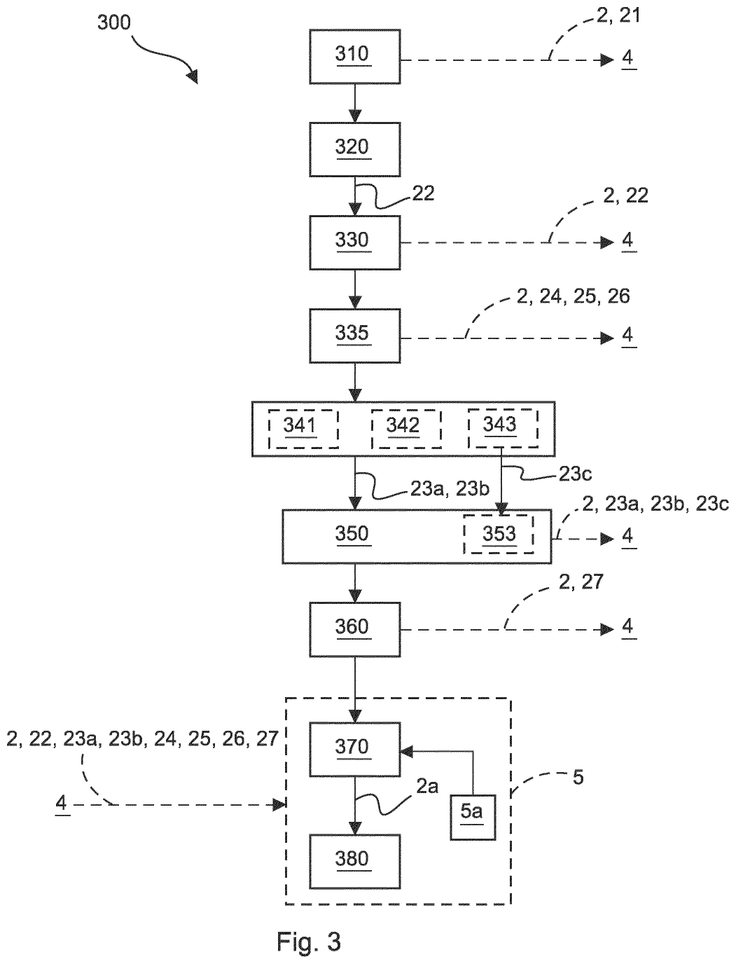

FIG. 3: Example of embodiment of method 300 for tracking the use of a batch of concrete 2;

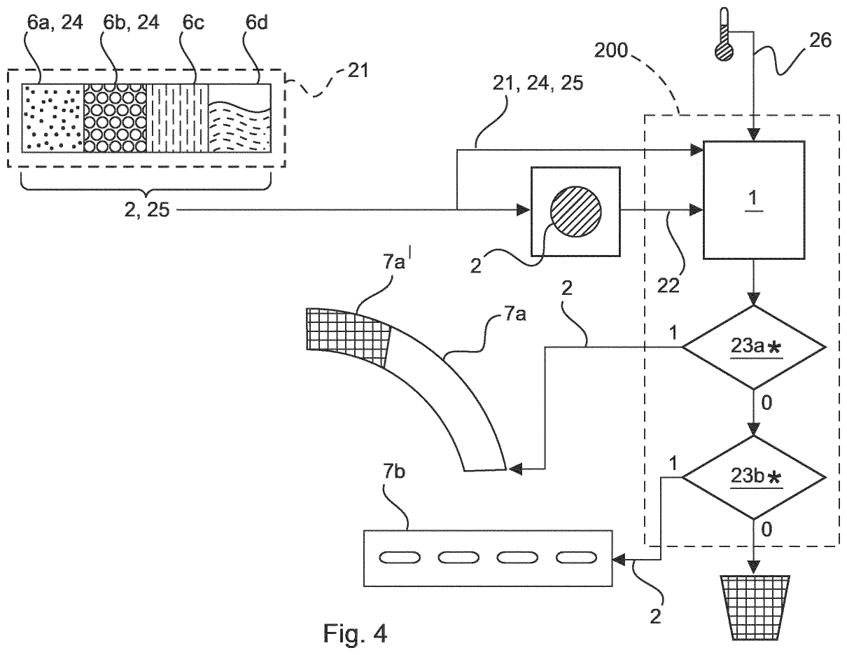

FIG. 4: Illustrative example of an application of method 200 at a construction site.

FIG. 1 shows an example flowchart of the method 100 for training the KNN 1. In step 110, learning data sets 3 are provided to “feed” the KNN. In the example shown in FIG. 1, each learning data set contains concrete 2 for a specific batch:
a set of characteristics 21 characterising the material composition of the batch 2, such as proportions by weight of constituents;
a measure 22 of the mechanical consistency of the batch 2, determined for example by the spreading test;
at least one value for a quality measure 23a, 23b characterizing the usability of the batch for at least one purpose on the construction site and determined, for example, by a human expert who has received the batch 2;
an identification 24 of the place where raw materials used for batch 2 were obtained;
an identification 25 of the supplier of batch 2; and
a measure 26 of the ambient temperature at the time the quality measure 23a, 23b is determined.

All of this information except for the quality measure 23a, 23b is provided as inputs 11 to the KNN 1 in step 120. Thereupon, the KNN 1 provides a prediction and/or classification 23a*, 23b* for the quality measure 23a, 23b. This prediction and/or classification 23a*, 23b* is compared in step 130 with the value for the quality measure 23a, 23b contained in the learning data set. The comparison provides a deviation Δ.

In step 140, a cost function (“loss function”) 14 is evaluated that dependsΔ on the deviation. In step 150, the parameters 12 of the KNN are adjusted with the optimization goal of improving the value of the cost function 14. For example, the parameters 12 may be successively adjusted using a gradient descent method until the average value of the cost function 14 obtained over all learning data sets 3 falls below a predetermined threshold.

According to block 121, the KNN 1 also provides a prediction 23c* for the climate variable 23c. According to block 131, this prediction 23c* is compared with the value for the climate variable 23c contained in the respective learning data set 3. The cost function 14 then additionally depends, according to block 141, on a deviation Δ′ determined in the comparison 131.

FIG. 2 shows an embodiment of the method 200 for predicting and/or classifying the usability of a batch of concrete 2 on a construction site. The method 200 assumes that a KNN, for example trained with the previously described method 100, is available.

In step 210, a set of parameters 21 characterizing the material composition of the batch 2 is determined. In step 220, at least one measure of the mechanical consistency of the batch 2 is determined, for example using the spreading test. Further, identification 24 of the location where raw materials for the batch 2 were obtained, identification 25 of the manufacturer of the batch 2, and a measure 26 of the ambient temperature at the construction site may also be used.

In step 230, the collected information is provided to the KNN 1 as inputs 11. The KNN 1 then outputs a prediction and/or classification 23a*, 23b* for at least one quality measure 23a, 23b relating to the usability of the batch 2 for at least one intended use on the construction site. Thus, a prediction and/or classification 23a*, 23b* is always related to the respective intended use. This prediction and/or classification 23a*, 23b* is retrieved from the KNN 1 in step 240.

In particular, this may involve the case where a first prediction and/or classification 23a* indicates that the batch 2 is likely to be unsuitable for a first intended use. In this case, in accordance with block 241, a second prediction and/or classification 23b* may be retrieved that relates to a measure of quality 23b for suitability for another use. For example, a batch 2 that is unsuitable for the construction of a particularly complicated yet highly loaded structure of the building or part of the building to be constructed may possibly be used for concreting a less critical structure.

According to block 242, at least one prediction and/or classification 23c* of a climate parameter 23c, which is a parameter for a climate impact to be attributed to the batch 2, may additionally be retrieved as an output 13 of the KNN 1.

In step 250, means may be controlled to deliver the batch 2 to the use for which it is suitable according to the prediction and/or classification 23a*, 23b*.

The corresponding quality criterion may additionally also depend on the predicted climate parameter 23c* for batch 2. As explained previously, a concrete can then be optimal, for example, that fulfils only slightly more than minimum requirements instead of the maximum requirements with regard to the classification 23a*, but has a significantly lower ecological “footprint” for this.

FIG. 3 shows an exemplary flowchart of the method 300 for tracking the use of a batch of concrete 2. In step 310, parameters 21 characterizing the material composition of the batch 2 are stored in the blockchain 4 in association with that batch 2. In step 320, a measure 22 of the mechanical consistency of the batch 2 is physically determined, for example using the standardized spreading test. The result is stored in step 330 in association with the batch 2 in the blockchain 4.

In step 340, a quality measure 23a, 23b is determined for the usability of the batch 2 for at least one intended use at the construction site. This quality measure 23a, 23b is stored in step 350 in association with the batch 2 in the blockchain 4.

According to block 341, the quality measure 23a, 23b may be determined as a prediction and/or classification 23a*, 23b* using the described method 200. According to block 342, the quality measure 23a, 23b may also be plausibilized with such a prediction and/or classification 23a*, 23b*, for example to prevent unjustified much too negative evaluations of the batch 2.

Pursuant to block 343, at least one climate metric 23c, which is a metric for a climate impact attributable to the batch 2, may also be determined and stored in the blockchain 4 in association with the batch 2 pursuant to block 353.

Further, in step 335, the identification 24 of the location where raw materials for the batch 2 were obtained, and/or the identification 25 of the manufacturer of the batch 2, and/or the measure 26 of the ambient temperature at the time when the quality measure 23a, 23b for the usability of the batch 2 was determined may also be stored in the blockchain 4.

In step 360, the actual use 27 for which the batch of concrete 2 is used at the construction site is stored in association with the batch 2 in the blockchain 4.

In step 370, a smart contract 5 operating on the blockchain 4 determines a price 2a for the batch 2 on the basis of all the data 22, 23a, 23b, 24, 25, 26, 27 previously stored in the blockchain 4 in association with the batch 2. The criteria 5a used in this process are fixed in the smart contract 5, “soldered in” as it were, and cannot be changed subsequently. In step 380, the Smart Contract 5 credits this price 2a to the supplier of batch 2.

FIG. 4 shows an illustrative example of how the use of a batch of concrete 2 at a construction site can be controlled by the method 200. In this example, the batch 2 has been mixed from four components: sand 6a, gravel 6b, cement 6c and water 6d.

The characteristics 21 indicate the mixing ratio of these components 6a-6d. The sand 6a and gravel 6b are sourced from natural reservoirs at a location 24, and the batch 2 has been produced by a manufacturer 25.

A spreading test is now first performed at the job site to determine the measure 22 of mechanical consistency of the batch 2. This measure 22, together with the characteristics 21, the identification 24 of the location, the identification 25 of the manufacturer and the measure 26 for the temperature at the construction site, is fed to the trained KNN 1.

On the basis of this information, the KNN 1 determines a first prediction and/or classification 23a* for a quality measure 23 relating to a first intended use, in this case concreting of a currently shuttered part 7a′ of a concrete arch 7a. If the quality of the batch 2 according to the prediction and/or classification 23a* is sufficient for this intended use (truth value 1), the batch 2 is used for this purpose.

If, on the other hand, the quality of batch 2 is not sufficient for this purpose (truth value 0), a second prediction and/or classification 23b* is called up for a quality measure 23b which relates to a less demanding purpose for batch 2, in this case the concreting of a construction road 7b. If the batch 2 is suitable for this purpose according to the prediction and/or classification 23b* (truth value 1), it is used accordingly. If, on the other hand, batch 2 is also not suitable for this less demanding purpose (truth value 0), batch 2 is discarded as waste.

### LIST OF REFERENCE SIGNS

1 Artificial neural network, KNN
11 Inputs of the KNN 1
12 Parameters of the KNN 1
13 Editions of the KNN 1
14 Cost function for training KNN 1
2 Batch of concrete
2a Price for batch 2
21 Key parameters characterising the composition of batch 2
22 Measure of mechanical consistency of batch 2
23a Quality measure of batch 2 for first purpose
23a* Prediction/classification of quality measure 23a provided by KNN 1
23b Quality measure of batch 2 for second purpose
23b* Prediction/classification of quality measure 23b provided by KNN 1
23c Climate variable, is measure of climate impact of batch 2
23c* Prediction/classification of climate variable 23c provided by KNN 1
24 Identification of the location where raw materials for batch 2 were obtained
25 Identification of the manufacturer of batch 2
26 Measure for temperature
27 Actual use of batch 2
3 Learning data set for training of KNN 1
4 Blockchain
5 Smart Contract, operates on blockchain 4
5a Criteria for pricing in Smart Contract 5
6a Sand
6b Gravel
6c Cement
6d Water
7a Concrete arch
7a′ Disconnected part of the concrete arch 7a
7b Building road
100 Procedure for training the KNN 1
110 Providing the learning data sets 3
120 Supply of inputs 11 to KNN 1
121 Deliver also prediction/classification 23c* by KNN 1
130 Compare prediction/classification 23a*, 23b* with quality measure 23a, 23b
131 Compare prediction/classification 23c* with climate variable 23c
140 Evaluating the cost function 14
141 Evaluate also the deviation determined in comparison 131 Δ′
150 Adjusting parameter 12 of KNN 1
200 Procedure for predicting/classifying the usability of batch 2
210 Determining the characteristics 21
220 Determining the measure of mechanical consistency of batch 2
230 Transferring the inputs 11 to the KNN 1
240 Retrieve prediction/classification 23a*, 23b* from KNN 1
241 Retrieve another prediction/classification 23a*, 23b*
242 Retrieve also the prediction/classification 23c* of the climate variable 23c
250 Taxation of funds for the addition of batch 2 for use
300 Procedure to track the use of a batch 2
310 Storage of identifiers 21 or hash values in blockchain 4
320 Determining the measure 22 for the mechanical consistency of batch 2
330 Deposit of measure 22 in the blockchain 4
335 Backgrounding further information 24, 25, 26 in the blockchain 4
340 Determining the quality measure 23a, 23b
341 Determining the quality measure 23a, 23b as a prediction/classification 23a*, 23b*
342 Plausibility check quality measure 23a, 23b./. Prediction/classification 23a*, 23b*
343 Determining the climatic variable 23c
350 Deposit of quality measure 23a, 23b in blockchain 4
353 Storage also of climate variable 23c in the blockchain 4
360 Deposit of actual use 27 in blockchain 4
370 Determining the price 2a on the basis of criteria 5a
380 Credit note of price 2a to supplier of batch 2
Δ Deviation determined in comparison 130
Δ′ Deviation determined in additional comparison 131

1. Method (100) for training an artificial neural network, KNN (1), which predicts and/or classifies at least one quality measure (23a, 23b) for the usability of a batch of concrete (2) on a construction site, the behavior of the KNN (1) being characterized by a set of parameters (12), comprising the steps of:
a set of learning data sets (3) is provided (110), each learning data set (3) comprising, for a batch of concrete (2), a set of characteristics (21) characterizing the material composition of the batch (2), at least one measure (22) of the mechanical consistency of the batch (2), and at least one value for a quality measure (23a, 23b) characterizing the usability of the batch (2) for at least one intended use on the construction site;
the KNN (1) is supplied (120), for each learning data set (3), with the set of characteristics (21) contained therein and the measure (22) of mechanical consistency contained therein as inputs (11), in order to obtain a prediction and/or classification (23a*, 23b*) for the at least one quality measure (23a, 23b) as output (13);
the prediction and/or classification (23a*, 23b*) for the quality measure (23a, 23b) is compared (130) with the value for the quality measure (23a, 23b) contained in the learning data set (3);
a cost function (14) is evaluated (140) which depends on a deviation Δ determined in the comparison (130);
the parameters (12), and/or the learning data sets (3), of the KNN (1) are adapted (150) with the optimization objective of improving the value of the cost function (14).

2. Method (100) according to claim 1, wherein
the KNN (1) additionally predicts and/or classifies at least one climatic parameter (23c) which is a parameter for a climatic effect to be attributed to the batch of concrete (2),
learning data set (3) each also comprise the value of the climate variable (23c) for the particular batch of concrete (2) to which they relate,
the KNN (1) additionally determines (121) a prediction (23c*) for the climate variable (23c) from the characteristics (21) and the measures (22) for the mechanical consistency in the learning data sets (3),
the prediction (23c*) for the climate variable (23c) is compared (131) with the value for the climate variable (23c) contained in the respective learning data set (3), and
the cost function (14) additionally depends (141) on a deviation Δ′ determined in this comparison (131).

3. Method according to claim 2, wherein the climate parameter (23c) includes a measure of the amount of at least one greenhouse gas emitted and/or sequestered in the batch of concrete (2) as a result of the production and/or use of the batch of concrete (2).

4. Method (100) according to any one of claims 1 to 3, wherein the learning data set (3) is additionally
an identification (24) of the place where at least one raw material used for the batch of concrete (2) was obtained, and/or
an identification (25) of the supplier of the batch of concrete (2), and/or
a measure (26) of the ambient temperature at the time the quality measure (23a, 23b) is determined, and/or
information on what is being built on the site, and/or
information as to where the batch of concrete (2) is delivered, and/or
at least partial planning data for the building to be constructed, and/or
at least one extract from a Building Information Model, BIM, of the building to be constructed, and/or
information on the origin, nature and/or consistency of at least one constituent of the batch of concrete (2), and/or
information as to the proportion of at least one constituent of the batch of concrete that is naturally derived material and the proportion of that constituent that is recycled material,
as further inputs (11) to be supplied to the KNN (1).

5. Artificial neural network, KNN (1), trained by the method (100) according to any one of claims 1 to 4.

6. Data set of parameters characterizing a KNN (1), obtained by the method (100) according to any one of claims 1 to 4.

7. Method (200) for predicting and/or classifying the usability of a batch of concrete (2) on a construction site, comprising the steps:
a set of characteristics (21) characterising the material composition of the batch (2) is determined (210);
at least one measure (22) of the mechanical consistency of the batch (2) is determined (220);
the characteristics (21) and the measure (22) of mechanical consistency are fed (230) to a trained KNN (1) as inputs (11);
at least one prediction and/or classification (23a*, 23b*) for a quality measure (23a, 23b) for the usability of the batch (2) for at least one intended use on the construction site is retrieved (240) as an output (13) from the KNN (1).

8. Method (200) according to claim 7, wherein at least one prediction and/or classification (23c*) of a climatic parameter (23c), which is a parameter for a climatic effect to be attributed to the batch of concrete (2), is additionally retrieved (242) as output (13) from the trained KNN (1).

9. Method according to claim 8, wherein the climate parameter (23c) includes a measure of the amount of at least one greenhouse gas emitted and/or sequestered in the batch of concrete (2) as a result of the production and/or use of the batch of concrete (2).

10. Method (200) according to any one of claims 7 to 9, wherein the KNN (1) is additionally provided with
an identification (24) of the place where at least one raw material used for the batch of concrete (2) was obtained, and/or
an identification (25) of the supplier of the batch of concrete (2), and/or
a measure (26) of the ambient temperature at the construction site are fed as inputs (11).

11. Method (200) according to any one of claims 7 to 10, wherein in response to a quality measure (23a*) predicted for a first use not satisfying a predetermined quality criterion, a further prediction and/or classification (23b*) for a second use is retrieved (241) as an output from a trained KNN (1).

12. Method (200) according to any one of claims 7 to 11, wherein in response to the quality measure (23a*, 23b*) predicted for a use satisfying a predetermined quality criterion, means for supplying the batch (2) to that use are controlled (250).

13. Method (200) according to claim 12, wherein the predetermined quality criterion additionally depends on the predicted climatic parameter (23c*) for the batch of concrete (2).

14. Method (300) for tracking the use of a batch of concrete (2) comprising the steps:
in association with the batch (2), a set of parameters (21) characterizing the material composition of the batch (2) and/or one or more hash values formed from these parameters (21) are stored (310) in a blockchain (4);
a measure (22) of the mechanical consistency of the batch (2) is physically determined (320) and stored (330) in association with the batch (2) in the blockchain (4);
a quality measure (23a, 23b) for the usability of the batch (2) for at least one intended use on the construction site is determined (340) and stored (350) in association with the batch (2) in the blockchain (4).

15. Method (300) according to claim 14, wherein in addition at least one climate parameter (23c), which is a parameter for a climate impact attributable to the batch of concrete (2), is determined (343) and stored (353) in association with the batch (2) in the blockchain (4).

16. Method according to any one of claims 14 to 15, wherein additionally
an identification (24) of the place where at least one raw material used for the batch of concrete (2) was obtained, and/or
an identification (25) of the supplier of the batch of concrete (2), and/or
a measure (26) of the ambient temperature at the time the quality measure (23a, 23b) is determined
be deposited in association with the batch (2) in the blockchain (4) (335).

17. Method (300) according to any one of claims 14 to 16, wherein the quality measure (23a, 23b) is determined (341) as a prediction and/or classification (23a*, 23b*) using the method (200) according to any one of claims 7 to 13, and/or is plausibilized (342) using a prediction and/or classification (23a*, 23b*) obtained using the method (200) according to any one of claims 7 to 13.

18. Method (300) according to any one of claims 14 to 17, wherein the actual use (27) for which the batch of concrete (2) is used at the construction site is stored (360) in association with the batch (2) in the blockchain (4).

19. Method (300) according to any one of claims 14 to 18, wherein a price (2a) for the batch (2) is determined (370) by a smart contract (5) operating on the blockchain (4) on the basis of the data stored in the blockchain (4) in association with the batch (2) according to predetermined criteria (5a) and credited (380) to the supplier of the batch (2).

20. Method (300) according to claim 19, wherein the predetermined criteria (5a) depend at least on the quality measure (23a, 23b) for the usability of the batch (2) for the at least one intended use on the construction site, and/or on the actual intended use for which the batch (2) was used on the construction site.

21. Method (300) according to claim 20, wherein the previously established criteria (5a) additionally depend on the climatic parameter (23c) for the batch (2).

22. One or more computer programs comprising machine-readable instructions that, when executed on one or more computers, and/or on a blockchain, cause the one or more computers, and/or the blockchain, to execute a method (100, 200, 300) according to any one of claims 1 to 21.

23. Machine-readable medium and/or download product comprising the one or more computer programs of claim 22.
